(19) United States
(12) Patent Application Publication
(10) Pub. No.: US 2026/0361026 A1
(43) Pub. Date: Nov. 12, 2026

(54) CONNECTOR AND WIRE-HARNESS END STRUCTURE

(71) Applicant: SUMITOMO WIRING SYSTEMS, LTD., Mie (JP)

(72) Inventor: Hiroki OKANO, Mie (JP)

(21) Appl. No.: 19/134,751

(22) PCT Filed: Nov. 20, 2023
(86) PCT No.: PCT/JP2023/041560

§ 371 Date: Jun. 2, 2025

(30) Foreign Application Priority Data
Dec. 9, 2022 (JP) 2022-196801

(51) Int. Cl. H01R 13/58

(52) U.S. Cl. CPC H01R 13/582

(57) ABSTRACT

A connector (20) comprises a housing (21) and a cover (24) that is mounted on the housing (21). The housing (21) has: a plurality of cavities (25) that extend in the front-rear direction and accommodate terminals (22) that are connected to end parts of electrical wires (90); and an electrical wire lead-out surface (21F) at which rear ends of the plurality of cavities (25) open so as to be aligned in the height direction and the width direction. The cover (24) has a back wall part (44) that is behind the electrical wire lead-out surface (21F) and forms an electrical wire routing space (49) with the electrical wire lead-out surface (21F). The back wall part has an electrical wire outlet (46) that is a flat opening that extends in the width direction at a position that is opposite one end surface part (21G) of the electrical wire lead-out surface (21F) that is on one side in the height direction with the electrical wire routing space (49) therebetween.

### TECHNICAL FIELD

The present disclosure relates to a connector, and a wire-harness end structure.

### BACKGROUND

Patent Document 1 discloses a flat cable pressure contact connector including a housing, a pressing cover, and a strain relief. Pressure contact terminals are accommodated in a terminal accommodation chamber of the housing. The pressure contact terminals each have an exposed portion exposed from the terminal accommodation chamber. The flat cable is brought into pressure contact with the exposed portions of the pressure contact terminals by the pressing cover. The strain relief holds the flat cable in a bent state between the strain relief and the pressing cover.

Patent Document 2 discloses a pressure contact connector including a housing, and an outer cover accommodating the housing. Wires extending from the housing are drawn upward through a wire drawing window that is open on an upper surface of a rear portion of the outer cover, and are further bent and led out rearward.

Patent Document 3 discloses a connector including a housing, and a pair of wire holding parts mounted to a rear end portion of the housing. Each of the wire holding parts includes a pair of upper and lower wire bending parts for bending wires.

Other structures in which wires (including a flat cable) are routed in a bent state within a cover are also disclosed in Patent Documents 4 and 5.

### Prior Art Document

### Patent Document

Patent Document 1: JP S62-198063 A
Patent Document 2: JP H08-037055 A
Patent Document 3: JP 2003-031298 A
Patent Document 4: JP 2003-168515 A
Patent Document 5: JP 2006-196349 A

### SUMMARY OF THE INVENTION

### Problems to be Solved

Meanwhile, cases where an increased number of wires are routed inside a cover due to an increase in the number of poles of terminals are difficult be dealt with by directly applying the techniques disclosed in Patent Document 1 to 5 above. For example, with the technique disclosed in Patent Document 1, it is difficult to bend a large number of wires because the wires are bent at an acute angle in the cover (between the strain relief and the housing), and, moreover, a wire routing path in the cover is narrow. In contrast, for example, if the strain relief structure is omitted, and the wire bending angle is set to be obtuse, an excessive stress acts on connection portions between the wires and the corresponding terminals when the wires are pulled rearward, resulting in the problem that the connection state between the wires and the terminals cannot be properly maintained.

Therefore, an object of the present disclosure is to reduce the stress acting on connection portions between wires and the corresponding terminals when the wires are pulled, while responding to the multiploidization of connectors.

### Means to Solve the Problem

The present disclosure is directed to a connector including: a housing; and a cover configured to be mounted to the housing, wherein the housing includes a plurality of cavities extending in a front-rear direction, and configured to accommodate terminals connected to end portions of wires, and a wire drawing surface on which rear ends of the plurality of cavities are open so as to be aligned in a height direction and a width direction, the cover includes, at a position rearward of the wire drawing surface, a back wall part that defines a wire routing space between the wire drawing surface and the back wall part, and the back wall part includes, at a position opposed to one end face part of the wire drawing surface on one end side in the height direction with the wire routing space disposed in between, a wire lead-out port extending in the width direction and having a flat opening shape.

### Effect of the Invention

According to the present disclosure, it is possible to reduce the stress acting on connection portions between wires and the corresponding terminals when the wires are pulled, while responding to the multiploidization of connectors.

### BRIEF DESCRIPTION OF THE DRAWINGS

FIG. 1 is a perspective view of a wire-harness end structure that includes a connector according to Embodiment 1 of the present disclosure.

FIG. 2 is an exploded perspective view of the connector.

FIG. 3 is a cross-sectional view of the connector in a state of being fitted to a counterpart connector.

FIG. 4 is an enlarged plan view of a cover of the connector and a peripheral portion thereof.

FIG. 5 is an enlarged side view of the cover of the connector and the peripheral portion thereof.

FIG. 6 is a rear view of the connector.

FIG. 7 is a rear view of a housing.

FIG. 8 is a perspective view of the cover as viewed from the front.

FIG. 9 is a perspective view of a first cover as viewed from the rear left.

FIG. 10 is a perspective view of a second cover as viewed from the rear right.

### DETAILED DESCRIPTION TO EXECUTE THE INVENTION

### Description of Embodiments of the Present Disclosure

First, aspects of the present disclosure will be listed and described.
(1) A connector according to the present disclosure includes a housing and a cover configured to be mounted to the housing, wherein the housing includes a plurality of cavities extending in a front-rear direction, and configured to accommodate terminals connected to end portions of wires, and a wire drawing surface on which rear ends of the plurality of cavities are open so as to be aligned in a height direction and a width direction, the cover includes, at a position rearward of the wire drawing surface, a back wall part that defines a wire routing space between the wire drawing surface and the back wall part, and the back wall part includes, at a position opposed to one end face part of the wire drawing surface on one end side in the height direction with the wire routing space disposed in between, a wire lead-out port extending in the width direction and having a flat opening shape.

With the above-described configuration, the wires drawn from the wire drawing surface of the housing to the wire routing space can be densely gathered in the wire lead-out port that is flat in the width direction, and led out rearward from the wire lead-out port in the dense state. Accordingly, it is possible to create a state in which the wires are less likely to move in the wire lead-out port. In particular, the wires drawn to the wire routing space from the rear ends of the cavities open at the other end face part of the wire drawing surface on the other end side in the height direction can be routed in an orientation inclined to the one end side in the height direction toward the wire lead-out port. As a result, tensile force generated when the wires are pulled rearward is less likely to be exerted on connection portions between the wires and the corresponding terminals, thus making it possible to properly maintain the connection state between the wires and the terminals.
(2) It is preferable that the cover includes a protrusion protruding into the wire routing space, and configured to bend a wire routing path to another end side in the height direction, the wire routing path being formed between the one end face part and the wire lead-out port.

With the above-described configuration, some (the wires on the one end side in the height direction) or all of the wires drawn to the wire routing space from the rear ends of the cavities open at the one end face part can be temporarily bent to the other end side in the height direction by the protrusion, and then routed from the bent position toward the wire lead-out port in an orientation inclined to the one side in the height direction. As a result, tensile force generated at the time of pulling the wires is further less likely to be exerted on the connection portions between the wires and the corresponding terminals, thus making it possible to more reliably maintain the connection state between the wires and the terminals.
(3) Preferably, the cover includes a pair of side wall parts intersecting the back wall part and closing end faces of the cover on both end sides in the width direction, and a base wall part intersecting the pair of side wall parts and closing an end face of the cover on the one end side in the height direction, and the protrusion has a plate shape, is disposed with a plate surface thereof oriented in the front-rear direction, and has a shape in which one end in the height direction is coupled to the base wall part, and both ends in the width direction are coupled to the corresponding side wall parts.

With the above-described configuration, the protrusion is coupled to both the base wall part and the side wall parts, and it is therefore possible to increase the rigidity of the protrusion. As a result, it is possible to prevent a situation where the protrusion is broken or damaged when tensile force generated at the time of pulling the wires is transmitted to the protrusion via the wires.
(4) Preferably, the cover includes a first cover and a second cover that are separable from each other, and the wire lead-out port includes a first wire lead-out port formed in the first cover, and a second wire lead-out port formed in the second cover and communicating with the first wire lead-out port.

With the above-described configuration, the first wire lead-out port and the second wire lead-out port can be communicated with each other concurrently with the first cover and the second cover being mounted to each other with the wires interposed therebetween, thus making it possible to form the wire lead-out port while the wires are routed thereinside. Accordingly, an operation of mounting the cover to the housing can be easily performed.
(5) It is preferable that a wire-harness end structure according to the present disclosure includes the connector according to any one of (1) to (4) above; and a flat harness part disposed at a position rearward of the cover and opposed to the wire lead-out port, and configured to bundle up a plurality of wires led out from the wire lead-out port to have an outer shape that is flat in the width direction.

With the above-described configuration, the flat harness part can be disposed at a position rearward of the wire lead-out port and opposed to the wire lead-out port, and the outer shape of the flat harness part can be a shape that is flat in the width direction and corresponds to the opening shape of the wire lead-out port. This allows the wires to be led out in a well-coordinated manner from the wire lead-out port to the flat harness part, thus making it possible to suppress undesired load from being applied to the wires.

### Details of Embodiments of the Present Disclosure

Specific examples of the present disclosure will be described. It should be noted that the present invention is not limited to these examples, but is defined by the claims, and is intended to include all modifications which fall within the scope of the claims and the meaning and scope of equivalents thereof.

### Embodiment 1

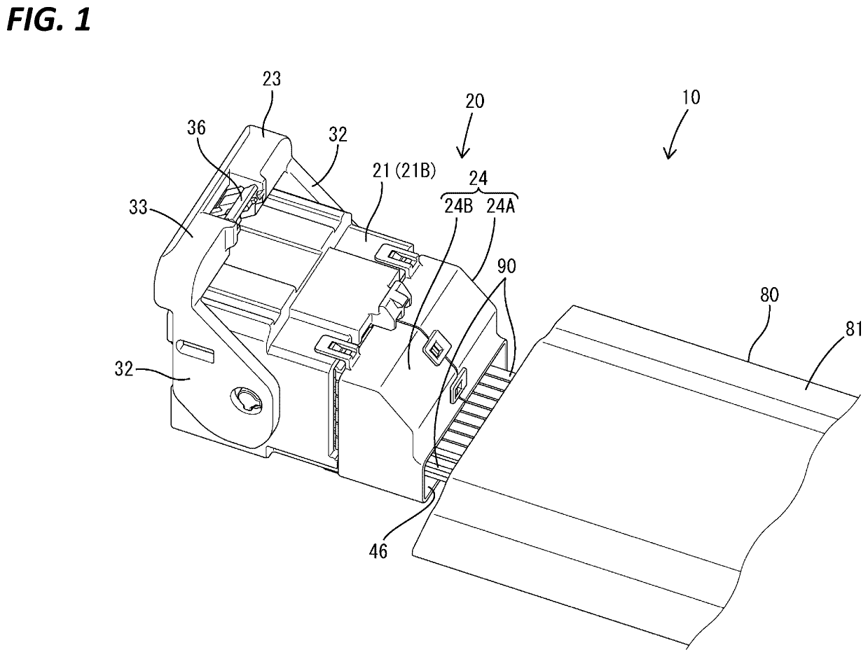

As shown in FIG. 1, a connector 20 according to Embodiment 1 of the present disclosure is provided at a distal end portion of a wire-harness end structure 10. The wire-harness end structure 10 includes, in the vicinity of the connector 20, a flat harness part 80 including a plurality of wires 90 led out from the connector 20.

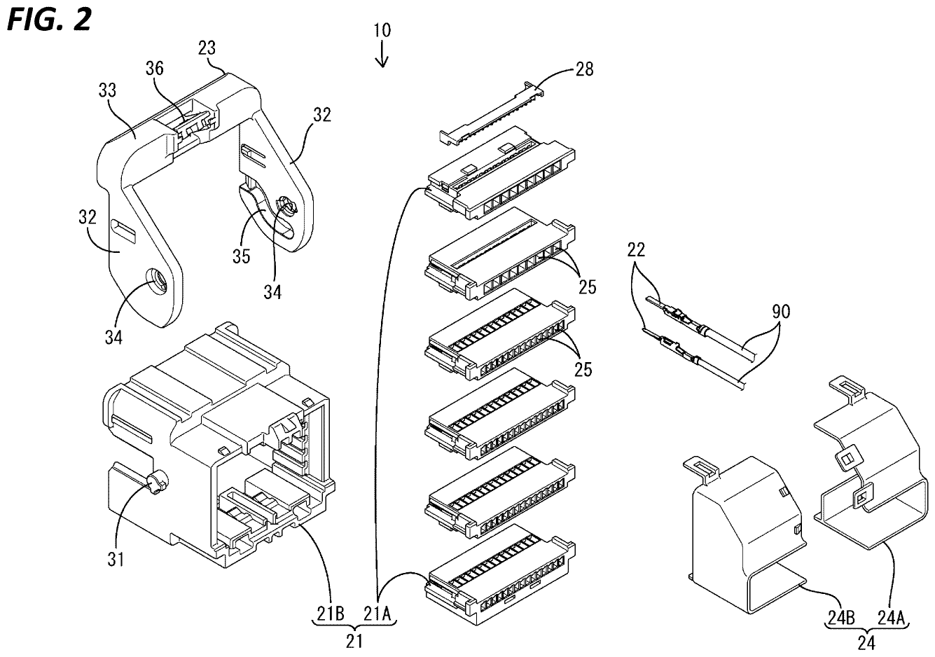

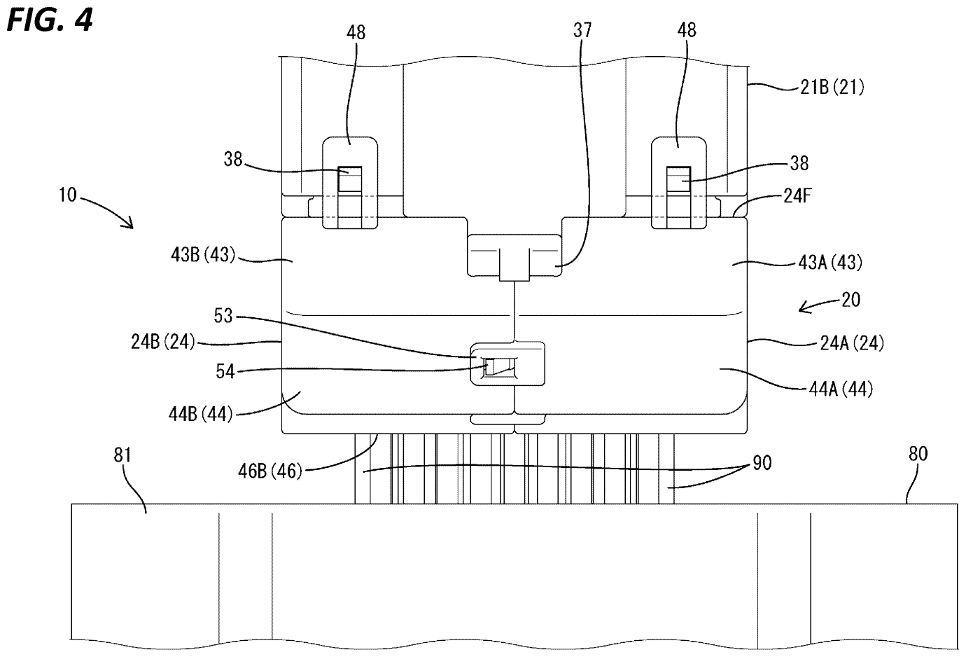

As shown in FIG. 2, the connector 20 includes a housing 21, a plurality of terminals 22 configured to be accommodated in the housing 21, a lever 23 configured to be pivotably supported by the housing 21, and a cover 24 configured to be mounted to the housing 21. The housing 21 is configured to be fitted to a counterpart connector 100. In the following description, a side where the housing 21 and the counterpart connector 100 are opposed to each other when fitted is the front side in the front-rear direction. The up-down direction is defined based on the up-down direction of the drawings excluding FIG. 4. The up-down direction is synonymous with the height direction. The left-right direction is defined based on the left-right direction of FIGS. 4, 6 and 7. The left-right direction is synonymous with the width direction. These directions do not necessarily coincide with the corresponding directions in a state in which the connector 20 is mounted in a vehicle or the like.

### Counterpart Connector

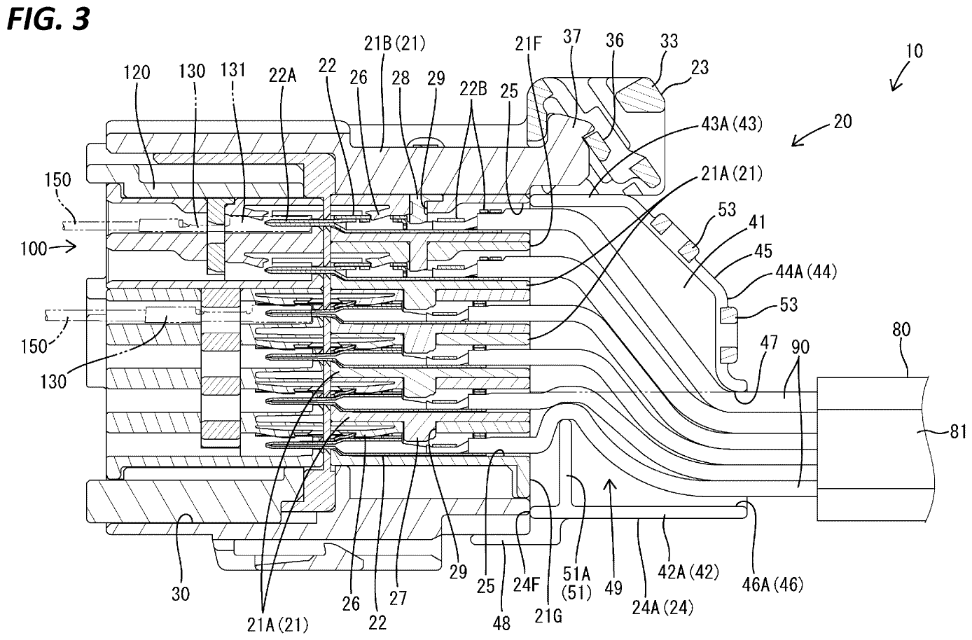

As shown in FIG. 3, the counterpart connector 100 includes a counterpart housing 120, and a plurality of counterpart terminals 130 accommodated in the counterpart housing 120. The counterpart housing 120 is made of synthetic resin, and has an overall shape of a rectangular block. The counterpart terminals 130 are each made of conductive metal, and are connected to end portions of the corresponding counterpart wires 150. The counterpart terminals 130 each have a tubular terminal connection part 131.

### Housing, Terminal, and Lever

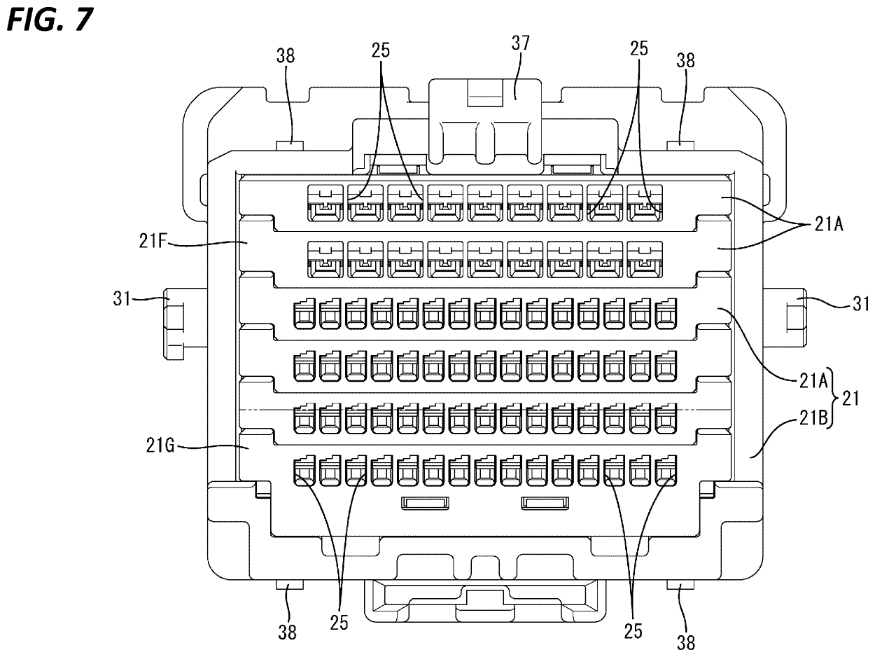

The housing 21 is made of synthetic resin, and is composed of a plurality of sub-housings 21A, and an outer housing 21B accommodating the sub-housings 21A as shown in FIGS. 3 and 7. The sub-housings 21A each have a shape that is flat in the width direction, and are disposed within the outer housing 21B while being stacked in the up-down direction. As shown in FIGS. 2 and 7, each of the sub-housings 21A includes a plurality of cavities 25. The cavities 25 are disposed in the sub-housing 21A so as to be aligned in a row in the width direction. As shown in FIG. 3, the sub-housing 21A includes elastically deformable lances 26 protruding from inner walls of the corresponding cavities 25.

Each terminal 22 is inserted into a cavity 25 from the rear, and is primarily locked by the corresponding lance 26. Each terminal 22 is made of conductive metal, and includes a forwardly protruding tab 22A, and a barrel part 22B formed on a rear end portion thereof and connected to an end portion (front end portion) of the corresponding wire 90, as shown in FIG. 3. At the time of fitting the housing 21 and the counterpart housing 120, the tab 22A of each of the terminals 22 is inserted into the terminal connection part 131 of the corresponding counterpart terminal 130, whereby the terminal 22 and the counterpart terminal 130 are electrically connected to each other.

As shown in FIG. 3, the terminals 22 inserted into the cavities 25 of the lower sub-housing 21A of two upper and lower sub-housings 21A adjacent to each other among the sub-housings 21A stacked in the up-down direction are secondarily locked to a retainer part 27 protruding from the upper sub-housing 21A. The terminals 22 inserted into the cavities 25 of the uppermost sub-housing 21A are secondarily locked by a separate retainer 28 (see FIG. 2) mounted to that sub-housing 21A. Each of the retainer part 27 and the retainer 28 protrudes into the cavities 25 through a retainer mounting hole 29 that is open on an upper surface of each of the sub-housings 21A, and locks the corresponding terminals 22.

As shown in FIG. 2, the outer housing 21B is a rectangular tubular casing perforated in the front-rear direction. The sub-housings 21A in the stacked state are inserted into the outer housing 21B from the rear, and are held therein. As shown in FIG. 3, the outer housing 21B includes a fitting space 30 that is open forward of front surfaces of the sub-housings 21A. The counterpart housing 120 is inserted into the fitting space 30 of the outer housing 21B and fitted therein. As shown in FIG. 7, a pair of support shafts 31 protrude from outer surfaces of two side walls of the outer housing 21B. The two support shafts 31 pivotably support the lever 23.

The lever 23 is made of synthetic resin, and includes a pair of arm parts 32 opposed to each other with an interval in the width direction, and a coupling part 33 extending in the width direction to couple the two arm parts 32, as shown in FIG. 2. Each of the two arm parts 32 has a shaft hole 34 and a cam groove 35 formed therein. An elastically deformable elastic lock part 36 is formed on the coupling part 33.

The lever 23 is pivotable relative to the housing 21 between a partial locking position (see FIG. 1) and a full locking position (see FIGS. 3, 5 and 6) around the support shafts 31 fitted into the corresponding shaft holes 34. At the partial locking position, the coupling part 33 is disposed above and away from a front end of the outer housing 21B (see FIG. 1). In the process in which the lever 23 is pivoted from the partial locking position to the full locking position, cam followers (not shown) formed on the counterpart housing 120 slide on groove surfaces of the corresponding cam grooves 35, whereby the fitting between the housing 21 and the counterpart housing 120 proceeds. At the full locking position, as shown in FIG. 3, the coupling part 33 is disposed above and close to a rear end of the outer housing 21B, and the elastic lock part 36 is locked to a lever lock part 37 formed on an upper wall of the outer housing 21B. As a result of the elastic lock part 36 being locked to the lever lock part 37, the lever 23 is held by the outer housing 21B while being restricted from being pivoted, and the housing 21 and the counterpart housing 120 are held in a fitted state. As shown in FIG. 4, the lever lock part 37 protrudes rearward from a central portion, in the width direction, of a rear end of the upper wall of the outer housing 21B so as to cover from above an upper wall part 43 of the cover 24, which will be described later.

As shown in FIG. 4, from an outer surface of the upper wall of the outer housing 21B, a pair of cover lock parts 38 protrude at positions on both sides in the width direction with the lever lock part 37 interposed therebetween. Each of the two cover lock parts 38 has a pawl shape, and locks the cover 24 to restrict disengagement of the cover 24 from the housing 21. As shown in FIG. 7, a pair of cover lock parts 38 in the width direction are also formed on an outer surface of a lower wall of the outer housing 21B. The two cover lock parts 38 formed on the lower wall of the outer housing 21B and the two cover lock parts 38 formed on the upper wall of the outer housing 21B are disposed at the same position in the width direction of the housing 21.

As shown in FIGS. 3 and 7, a rear surface of the housing 21 is disposed along the height direction and the width direction, and is formed as a wire drawing surface 21F from which the wires 90 are drawn from rear ends of the corresponding cavities 25. On the wire drawing surface 21F of the housing 21, the rear ends of the cavities 25 of the sub-housings 21A in a stacked state are open so as to be aligned in the height direction and the width direction.

### Cover

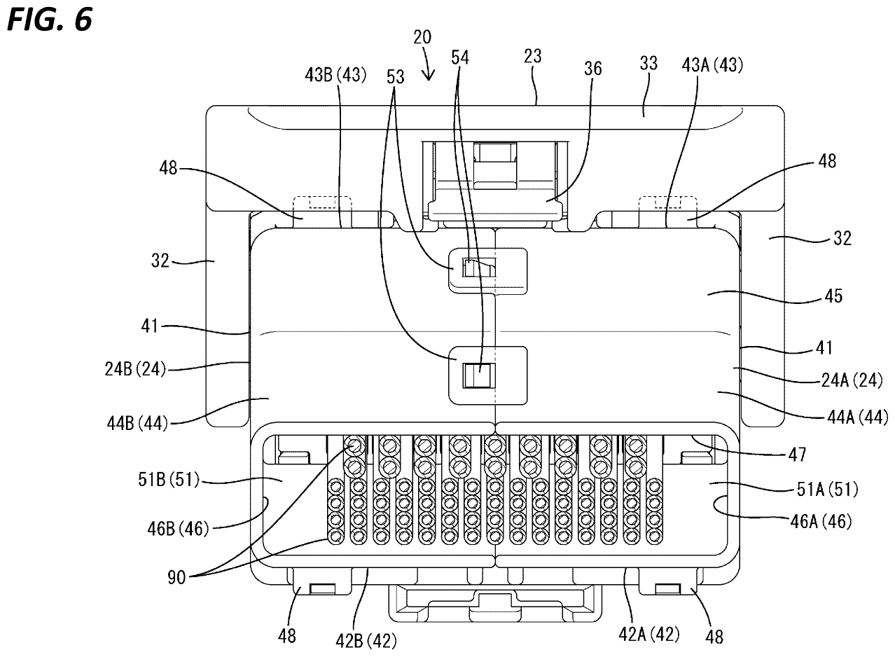

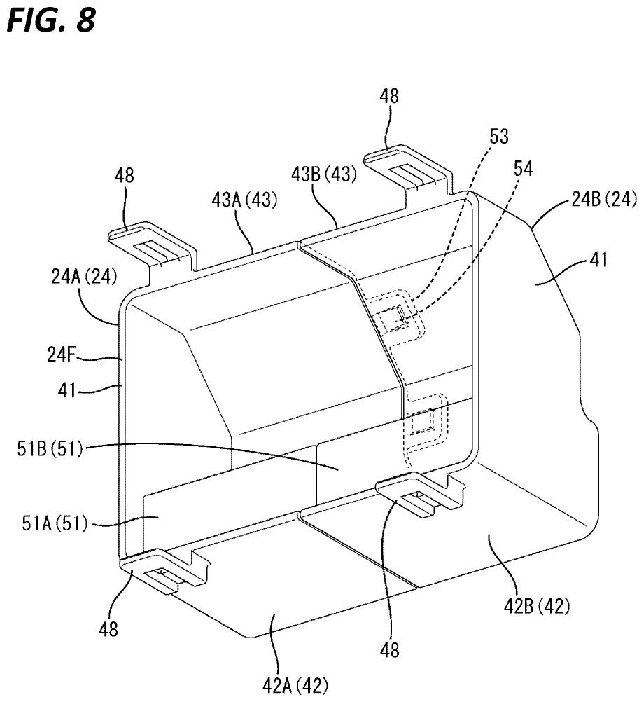

The cover 24 is made of synthetic resin, has a cap shape, and is mounted to a rear end portion of the housing 21 from the rear. As shown in FIG. 8, the cover 24 includes a pair of side wall parts 41, a base wall part 42, an upper wall part 43, and a back wall part 44. The two side wall parts 41 each have a plate shape along the height direction, and are opposed to each other at an interval in the width direction. The base wall part 42 has a plate shape along the width direction, extends in the width direction to be coupled to lower ends of the side wall parts 41, and closes a lower surface (an end face on one side in the height direction) of the cover 24. The upper wall part 43 has a plate shape along the width direction, extends in the width direction to be coupled to upper ends of the side wall parts 41, and closes an upper surface (an end face on the other side in the height direction) of the cover 24. The back wall part 44 has a plate shape with a plate surface thereof oriented in the front-rear direction, extends in the height direction to be coupled to the respective rear ends of the side wall parts 41, the base wall part 42, and the upper wall part 43, and closes a rear surface of the cover 24 except for a wire lead-out port 46, which will be described later, as shown in FIG. 6.

As shown in FIG. 8, the respective front ends of the two side wall parts 41, the base wall part 42, and the upper wall part 43 constitute an open end 24F of the cover 24 that has a quadrangular shape in a front view. The upper wall part 43 is shorter than the base wall part 42 in the front-rear direction. As shown in FIG. 3, an upper portion of the back wall part 44 constitutes an inclined surface part 45 that is inclined forward toward a rear end of the upper wall part 43. An upper portion of a rear end of each of the side wall parts 41 is coupled to the inclined surface part 45, and is inclined forward along the inclined surface part 45.

As shown in FIG. 6, a wire lead-out port 46 extends through a lower portion of the back wall part 44. The wire lead-out port 46 has a horizontally elongated, flat opening shape extending in the width direction. Specifically, the wire lead-out port 46 has a width dimension larger than a height dimension thereof, and is open over the full width of the back wall. Both ends in the width direction of the wire lead-out port 46 are defined by lower portions of the rear ends of the corresponding side wall parts 41. In addition, the wire lead-out port 46 is open at a lower portion (a portion located lower than the center of the back wall part 44 in the height direction) of the back wall part 44. A lower end of the wire lead-out port 46 is defined by a rear end of the base wall part 42, and is disposed along the width direction. As shown in FIG. 3, above the wire lead-out port 46, a lead-out guide part 47 is formed on the lower portion of the back wall part 44 so as to be curved rearward. As shown in FIG. 6, an upper end of the wire lead-out port 46 is defined by a rear end of the lead-out guide part 47, and is disposed along the width direction. The upper end, the lower end, and the both ends in the width direction of the wire lead-out port 46 are disposed at the same position in the front-rear direction, and are formed at the rearmost end of the cover 24.

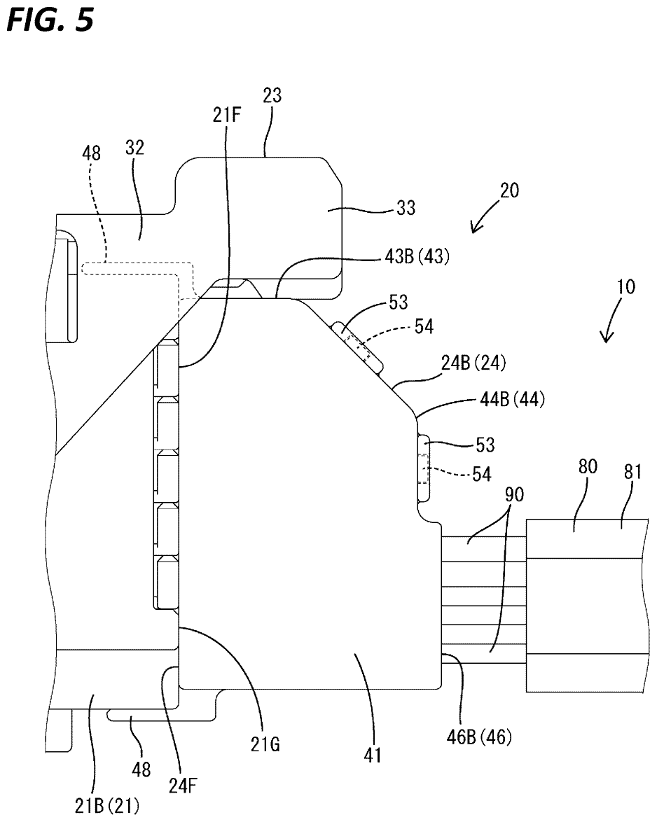

As shown in FIGS. 6 and 8, a pair of lock parts 48 disposed at an interval in the width direction are formed on a front end portion of each of the upper wall part 43 and the base wall part 42. The lock parts 48 each have a U-shape in a plan view, protrude forward from the respective front end portions of the upper wall part 43 and the base wall part 42, and are elastically deformable in the up-down direction. The lock parts 48 are locked to the corresponding cover lock parts 38. As a result of the lock parts 48 being locked to the cover lock parts 38, the open end 24F of the cover 24 is disposed in contact with an outer peripheral edge portion of the wire lead-out port 46 of the housing 21, whereby the cover 24 is held in the housing 21. As shown in FIG. 3, a wire routing space 49 is formed between the wire drawing surface 21F and the back wall part 44 in the cover 24. As shown in FIG. 5, when the lever 23 is at the full locking position, the coupling part 33 of the lever 23 is disposed so as to be placed opposed to an upper surface of the upper wall part 43.

As shown in FIG. 3, the wire lead-out port 46 is disposed at a position opposed, with the wire routing space 49 disposed in between, to one end face part 21G at which rear ends of the lowermost cavities 25 are open on the lower end side of the wire drawing surface 21F of the housing 21. The one end face part 21G is formed on the wire drawing surface 21F of the housing 21 so as to have a height dimension corresponding to the height of the wire lead-out port 46 in the same height range (the range from the lower end of the wire drawing surface 21F to the dashed double-dotted line in FIG. 3 as the upper limit) as the wire lead-out port 46.

On the front end side of the base wall part 42, a protrusion 51 protrudes into the wire routing space 49 is formed. The protrusion 51 has a plate shape, and is disposed with a plate surface thereof oriented in the front-rear direction. The protrusion 51 is elongated in the width direction, and both ends thereof in the width direction are coupled to the corresponding side wall parts 41. Thus, the protrusion 51 closes the front end side of a lower end portion of the wire routing space 49 on the rear side of the one end face part 21G. When the connector 20 is viewed in a rear view, the protrusion 51 is visible through the wire lead-out port 46, whereas the rear ends of the lowermost cavities 25 open at the one end face part 21G are hidden by the protrusion 51 and are not visible (see FIG. 6).

As shown in FIGS. 2 and 8, the cover 24 is composed of a first cover 24A and a second cover 24B that are separable from each other in the width direction. In other words, the cover 24 is formed by combining the first cover 24A and the second cover 24B from the width direction.

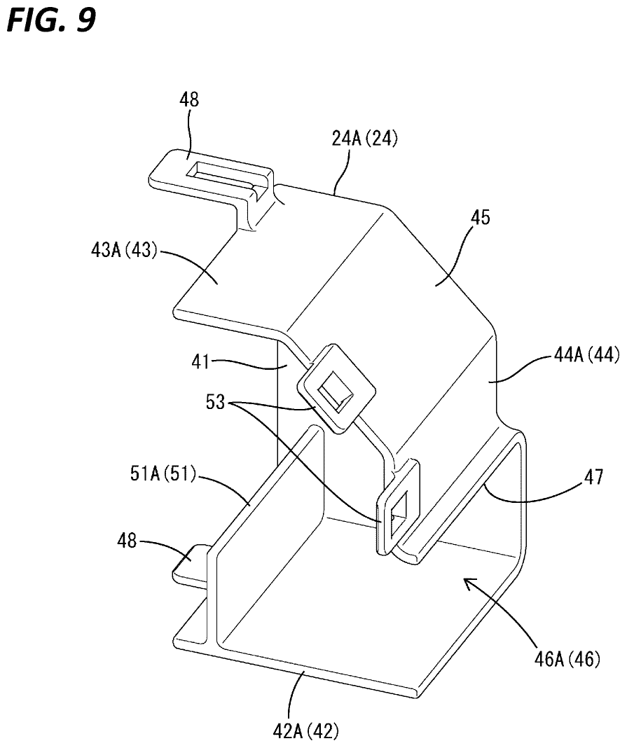

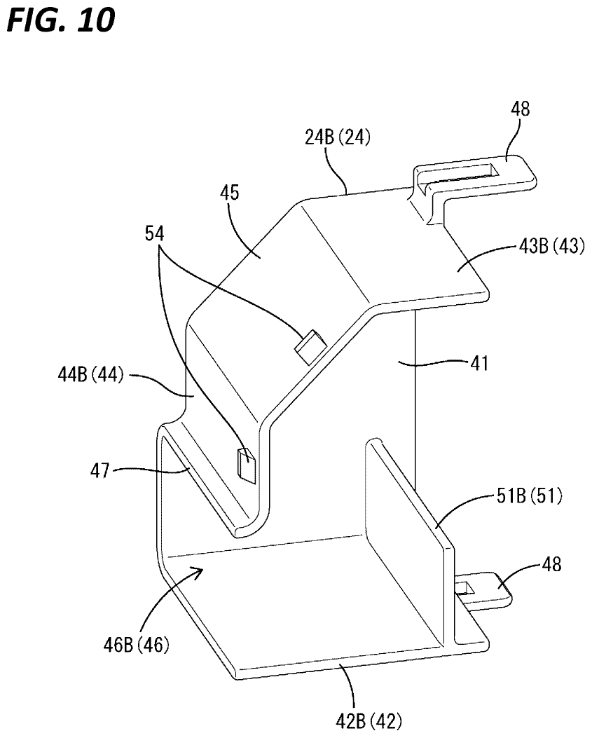

As shown in FIG. 6, the first cover 24A is disposed on the right side (one side in the width direction) of the connector 20 as viewed in a rear view, and constitutes the right half of the cover 24. The second cover 24B is disposed on the left side (the other side in the width direction) of the connector 20 as viewed in a rear view, and constitutes the left half of the cover 24. In the following description, “right side” and “left side” are defined based on “right side” and “left side” as viewed in a rear view. As shown in FIG. 9, the first cover 24A includes the right side wall part 41, a first base wall part 42A constituting a right portion of the base wall part 42, a first upper wall part 43A constituting a right portion of the upper wall part 43, and a first back wall part 44A constituting a right portion of the back wall part 44. The right lock parts 48 are formed on the first cover 24A. The first cover 24A includes a first protrusion 51A constituting a right portion of the protrusion 51, and a first wire lead-out port 46A constituting a right portion of the wire lead-out port 46. As shown in FIG. 10, the second cover 24B includes the left side wall part 41, a second base wall part 42B constituting a left portion of the base wall part 42, a second upper wall part 43B constituting a left portion of the upper wall part 43, a second back wall part 44B constituting a left portion of the back wall part 44, the left lock parts 48, a second protrusion 51B constituting a left portion of the protrusion 51, and a second wire lead-out port 46B constituting a right portion of the wire lead-out port 46. As shown in FIG. 8, the protrusion 51 is separated into the first protrusion 51A and the second protrusion 51B at a central portion of the cover 24 in the width direction. Similarly, the wire lead-out port 46 communicates with and is separated into the first wire lead-out port 46A and the second wire lead-out port 46B at the central portion of the cover 24 in the width direction.

As shown in FIG. 9, the first cover 24A includes a pair of upper and lower first locking parts 53 protruding from the first back wall part 44A to the other side in the width direction, which is the second back wall part 44B side. The two first locking parts 53 each have a U-shape in a plan view, and are disposed at an upper portion (a right portion of the inclined surface part 45) and a lower portion, respectively, of the first back wall part 44A so as to be elastically deformable. As shown in FIG. 10, the second cover 24B includes a pair of upper and lower second locking parts 54 protruding from an outer surface of the second back wall part 44B that is located toward the one side in the width direction, which is the first back wall part 44A side. The two second locking parts 54 each have a pawl shape, and are disposed at an upper portion (a left portion of the inclined surface part 45) and a lower portion, respectively, of the second back wall part 44B. As shown in FIG. 6, the two second locking parts 54 are locked to the corresponding first locking parts 53. As a result of the two second locking parts 54 being locked to the two first locking parts 53, the first cover 24A and the second cover 24B are integrated into a single piece. Thereafter, the first cover 24A and the second cover 24B are fitted and locked to the housing 21 from the rear, and is held in an immobile state.

### Flat Harness Part

As shown in FIG. 1, the flat harness part 80 is disposed rearward of the wire lead-out port 46 and opposed to the wire lead-out port 46. The flat harness part 80 has a flat cross-sectional shape corresponding to the wire lead-out port 46, and is disposed in a range of the wire-harness end structure 10 that overlaps the wire lead-out port 46 in the height direction and the width direction.

As shown in FIGS. 3 and 6, the wires 90 are led out from the wire lead-out port 46 in a state in which the wires 90 are densely stacked while maintaining the stacked state (stacked order) of the sub-housings 21A accommodating the wires 90. The wires 90 led out from the wire lead-out port 46 are arranged on fusion sheets (not shown) layer by layer, then sandwiched between the fusion sheets from the up-down direction, and subjected to a fusion process such as ultrasonic fusion or heat fusion, thereby being molded as a flat harness part 80 that is flat in the width direction. In short, the flat harness part 80 is obtained by integrating the wires 90 into a single piece by subjecting the layers to the fusion process at the end portion 81 while maintaining the stacked state. The front-to-rear length of the flat harness part 80 may be any length, and may be decided as appropriate depending on the situation. In addition, the flat harness part 80 can be attached to an attachment surface (not shown).

### Operations of Connector and Wire-Harness End Structure

At the time of assembly of the cover 24, the first cover 24A and the second cover 24B are combined from the width direction, relative to the wires 90 exposed between the sub-housings 21A and the flat harness part 80. As a result of the first locking parts 53 and the corresponding second locking parts 54 being locked to each other, a single-piece cover 24 is formed in a state in which the wires 90 are passed through the interiors of the first cover 24A and the second cover 24B.

Subsequently, the sub-housings 21A are inserted into the outer housing 21B from the rear, and the sub-housings 21A are held in the outer housing 21B in a stacked state in the up-down direction. Then, the cover 24 is mounted to the outer housing 21B from the rear side, and the lock parts 48 and the corresponding cover lock parts 38 are locked to each other, whereby the cover 24 is held and retained in the housing 21. Thereafter, the housing 21 is fitted to the counterpart connector 100 by a pivoting operation of the lever 23.

As shown in FIG. 3, the wires 90 drawn from the rear ends of the cavities 25 of the upper and middle sub-housings 21A (the third to sixth sub-housings 21A from the bottom in the case of FIG. 3) are inclined downward and extend in the wire routing space 49 of the cover 24 to reach the wire lead-out port 46 open on the lower end side of the back wall part 44, and are guided by the lead-out guide part 47 and led out rearward from the wire lead-out port 46. In the wire routing space 49, the wires 90 are gradually gathered in a dense state from the wire drawing surface 21F (rear end) of the housing 21 to the wire lead-out port 46. The wires 90 drawn from the rear ends of the cavities 25 of the lower sub-housings 21A (the first to second sub-housings 21A from the bottom in the case of FIG. 3) are pressed by the protrusion 51 and temporarily lifted upward. After moving over the protrusion 51, the wires 90 are inclined downward and extend to reach the wire lead-out port 46, and are led out rearward from the wire lead-out port 46. Here, the wires 90 drawn from the rear ends of the cavities 25 of the lowermost sub-housing 21A are pushed up by the upper end of the protrusion 51 and brought into contact with the upper adjacent wires 90, thereby being curved at the position corresponding to the protrusion 51.

As shown in FIGS. 3 and 6, in the wire lead-out port 46 of the back wall part 44, the wires 90 are pressed against the upper end (lead-out guide part 47) of the wire lead-out port 46 while maintaining the stacked state of the sub-housings 21A, and densely gathered while being biased upward. Then, as shown in FIGS. 1, 4 and 5, the wires 90 led out from the wire lead-out port 46 of the back wall part 44 are directly moved linearly rearward and introduced inside the flat harness part 80.

In the case of Embodiment 1, the lock parts 48 and the cover lock parts 38 are disposed point-symmetrical positions when the connector 20 is viewed in a rear view. Accordingly, the cover 24 can also be mounted to the housing 21 in an opposite orientation from the orientation described above. When the cover 24 assumes the opposite orientation from the above-described orientation, the wire lead-out port 46 is open on the upper end side of the back wall part 44, and the one end face part 21G is located on the upper end side of the wire drawing surface 21F. Accordingly, the routing configuration of the wires 90 in the wire routing space 49 is reversed from the routing configuration described above.

According to Embodiment 1, the wires 90 are passed through the wire lead-out port 46 of the back wall part 44 in a dense state, and are further disposed in a bent or inclined state in the wire routing space 49 of the cover 24. Accordingly, even if rearward tensile force acts on the wires 90 extending rearward from the flat harness part 80, or on the flat harness part 80, it is possible to restrict the movement of the wires 90 in the wire lead-out port 46, and also maintain the routing state of the wires 90 in the wire routing space 49. Therefore, it is possible to prevent the above-described tensile force from being exerted on the connection portions (portions connected by the barrel part 22B) between the wires 90 and the corresponding terminals 22 at the end portions of the wires 90. As a result, it is possible to properly maintain the connection state between the wires 90 and the terminals 22. In particular, in the case of Embodiment 1, it is possible to restrict the movement of the wires 90 without reducing or complicating the wire routing path in the cover 24. This makes it possible to accommodate multipolar connectors.

The wire routing path from the one end face part 21G of the wire drawing surface 21F of the housing 21 to the wire lead-out port 46 is bent upward by the protrusion 51. Accordingly, the wires 90 drawn from the rear ends of the cavities 25 of the lower sub-housings 21A can be passed through the wire routing space 49 in a bent state. As a result, it is possible to more reliably prevent the above-described tensile force from being exerted on the connection portions between the wires 90 and the corresponding terminals 22.

The lower end of the protrusion 51 is coupled to the base wall part 42, and the both ends of the protrusion 51 in the width direction are coupled to the corresponding side wall parts 41. Accordingly, the rigidity of the protrusion 51 can be increased, thus making it possible to prevent a situation where the protrusion 51 is broken or damaged when tensile force acts thereon.

The cover 24 is composed of the first cover 24A and the second cover 24B, and the first wire lead-out port 46A and the second wire lead-out port 46B can be communicated with each other concurrently with the first cover 24A and the second cover 24B being mounted to each other with the wires 90 interposed therebetween, thus making it possible to form the wire lead-out port 46 while the wires 90 are routed thereinside. Accordingly, an operation of mounting the cover 24 to the housing 21 can be easily performed.

Furthermore, the wire-harness end structure 10 according to Embodiment 1 includes, at a position rearward of the cover 24 and opposed to wire lead-out port 46, the flat harness part 80 that bundles up the wires 90 led out from the wire lead-out port 46. The outer shape of the flat harness part 80 is a shape that is flat in the width direction and corresponds to the opening shape of the wire lead-out port 46. This allows the wires 90 to be led out in a well-coordinated manner from the wire lead-out port 46 to the flat harness part 80, thus making it possible to suppress undesired load from being applied to the wires 90. Moreover, the stacked state of the wires 90 can be maintained while the sub-housings 21A corresponding to the wires 90 are kept in a stacked state.

### Other Embodiments of the Present Disclosure

It should be appreciated that Embodiment 1 presently disclosed is in all respects illustrative and not limiting.

In the case of Embodiment 1 above, the cover includes the protrusion protruding into the wire routing space. In contrast, according to other embodiments, the cover need not include the protrusion protruding into the wire routing space.

In the case of Embodiment 1 above, the protrusion is coupled to both the base wall part and the side wall parts. In contrast, according to other embodiments, the protrusion need only be coupled to either the base wall part or the side wall parts.

In the case of Embodiment 1 above, the cover is composed of the first cover and the second cover that are separate from each other. In contrast, according to other embodiments, the cover may be formed as a single piece using a flexible hinge that connects the first cover and the second cover. Alternatively, the cover may be a rigid member formed as a single piece as a whole without including any hinge.

In the case of Embodiment 1 above, the flat harness part is formed by resin-coating the wires led out from the wire lead-out port so as to have an outer shape that is flat in the width direction. In contrast, according to other embodiments, the flat harness part may be formed by holding the wires led out from the wire lead-out port with a clamp, tape, or the like so as to have an outer shape that is flat in the width direction.

### LIST OF REFERENCE NUMERALS

10 Wire-harness end structure
20 Connector
21 Housing
21A Sub-housing
21B Outer housing
21F Wire drawing surface
21G One end face part
22 Terminal
22A Tab
22B Barrel part
23 Lever
24 Cover
24A First cover
24B Second cover
24F Open end
25 Cavity
26 Lance
27 Retainer part
28 Retainer
29 Retainer mounting hole
30 Fitting space
31 Support shaft
32 Arm part
33 Coupling part
34 Shaft hole
35 Cam groove
36 Elastic lock part
37 Lever lock part
38 Cover lock part
41 Side wall part
42 Base wall part
42A First base wall part
42B Second base wall part
43 Upper wall part
43A First upper wall part
43B Second upper wall part
44 Back wall part
44A First back wall part
44B Second back wall part
45 Inclined surface part
46 Wire lead-out port
46A First wire lead-out port
46B Second wire lead-out port
47 Lead-out guide part
48 Lock part
49 Wire routing space
51 Protrusion
51A First protrusion
51B Second protrusion
53 First locking part
54 Second lock part
80 Flat harness part
81 End portion
90 Wire
100 Counterpart connector
120 Counterpart housing
130 Counterpart terminal
131 Terminal connection part
150 Counterpart wire

1. A connector comprising:
a housing; and
a cover configured to be mounted to the housing, wherein
the housing includes a plurality of cavities extending in a front-rear direction, and configured to accommodate terminals connected to end portions of wires, and a wire drawing surface on which rear ends of the plurality of cavities are open so as to be aligned in a height direction and a width direction,
the cover includes, at a position rearward of the wire drawing surface, a back wall part that defines a wire routing space between the wire drawing surface and the back wall part,
the back wall part includes, at a position opposed to one end face part of the wire drawing surface on one end side in the height direction with the wire routing space disposed in between, a wire lead-out port extending in the width direction and having a flat opening shape,
the cover includes a protrusion protruding into the wire routing space, and configured to bend a wire routing path to another end side in the height direction, the wire routing path being formed between the one end face part and the wire lead-out port,
the protrusion has a plate shape with a plate surface thereof oriented in the front-rear direction, and is located rearward of the one end face part, and,
when the connector is viewed in a rear view, the protrusion is visible through the wire lead-out port, and rear ends of the cavities that are open at the one end face part are not visible through the wire lead-out port.

2. The connector according to claim 1, wherein
the protrusion closes the wire routing space over a full width in the width direction.

3. The connector according to claim 2, wherein
the cover includes a pair of side wall parts intersecting the back wall part and closing end faces of the cover on both end sides in the width direction, and a base wall part intersecting the pair of side wall parts and closing an end face of the cover on the one end side in the height direction, and
the protrusion has a shape in which one end in the height direction is coupled to the base wall part, and both ends in the width direction are coupled to the corresponding side wall parts.

4. The connector according to claim 1, wherein
the cover includes a first cover and a second cover that are separable from each other, and the wire lead-out port includes a first wire lead-out port formed in the first cover, and a second wire lead-out port formed in the second cover and communicating with the first wire lead-out port.

5. A wire-harness end structure, comprising:
the connector according to claim 1; and
a flat harness part disposed at a position rearward of the cover and opposed to the wire lead-out port, and configured to bundle up a plurality of wires led out from the wire lead-out port to have an outer shape that is flat in the width direction.
